(19) United States
(12) Patent Application Publication
(10) Pub. No.: US 2015/0343740 A1
(43) Pub. Date: Dec. 3, 2015

(54) VARIABLE ELASTIC MODULUS MATERIAL AND METHOD FOR PRODUCING THE SAME

(71) Applicant: HONDA MOTOR CO., LTD., Tokyo (JP)

(72) Inventor: Toshio Inoue, Wako-shi (JP)

(73) Assignee: HONDA MOTOR CO., LTD., Tokyo (JP)

(21) Appl. No.: 14/718,562

(22) Filed: May 21, 2015

(30) Foreign Application Priority Data
Jun. 2, 2014 (JP) 2014-113778

(51) Int. Cl. B32B 7/00

(52) U.S. Cl. CPC B32B 7/005; B32B 2605/00; B33Y 10/00

(57) ABSTRACT

A variable elastic modulus material includes first elastic members in which particles that are magnetically polarized under the influence of magnetic field are dispersed and a second elastic member that is different from the first elastic members and serves as a base material. The first elastic members are disposed in the second elastic member. In a method for producing a variable elastic modulus material, supplying a base material of a second elastic member to a molding die with first elastic members being arranged in the molding die.

### CROSS REFERENCES TO RELATED APPLICATIONS

The present application claims priority under 35 U.S.C. §119 to Japanese Patent Application No. 2014-113778, filed Jun. 2, 2014, entitled “Variable Elastic Modulus Material And Method For Producing The Same.” The contents of this application are incorporated herein by reference in their entirety.

### TECHNICAL FIELD

The present disclosure relates to a variable elastic modulus material whose elastic modulus varies in accordance with the intensity of a magnetic field applied to the material and relates to a method for producing the material.

### BACKGROUND

A known variable elastic modulus material (a magneto-rheological elastomer) has an elastic modulus that varies in accordance with the intensity of a magnetic field applied to the material. Japanese Unexamined Patent Publication No. 2012-227411, for example, describes a structure including an elastic base material having a large number of pores and magnetic particles included in an additive embedded in some of the pores.

As well as Japanese Unexamined Patent Publication No. 2012-227411, some methods have been proposed as methods for producing such variable elastic modulus materials. In one method (method 1), magnetic particles (metal powder) are mixed in a base material (rubber) of a variable elastic modulus material and sufficiently dispersed in the base material, and a magnetic field is applied to the mixture so that the magnetic particles are oriented in a predetermined direction and compressed, thereby obtaining a variable elastic modulus material. In another method (method 2), a large number of pores are formed in a rubber body and magnetic particles are poured into the pores, thereby obtaining a variable elastic modulus material.

### SUMMARY

In Japanese Unexamined Patent Publication No. 2012-227411, the elastic body serving as the base material is limited to a porous material, and thus, is not versatile. In addition, it is difficult to include the additive uniformly in the pores of the base material. It is also difficult to control the proportion of magnetic particles in the additive.

In method 1 described above, the state in which the magnetic particles are properly oriented when a strong magnetic field is applied needs to be held for a long period. Thus, the time necessary for production is long (i.e., productivity is poor) in the case of manufacturing, and the production cost is high. In method 2, it is difficult to insert magnetic particles in the case of slender holes. On the other hand, in the case of wide holes, it is difficult to control a magnetic field in order to adjust the rigidity of the entire variable elastic modulus material. In this method, it is difficult to adjust a variation among products in manufacturing. This might cause a decrease in the yield or the necessity for reducing the control effect in order to obtain control stability of the elastic modulus.

The present application describes a variable elastic modulus material that is made of a versatile base material, can be easily produced, and can easily reduce variations in response to a magnetic field. The present application also describes a method for easily producing a variable elastic modulus material with stable properties.

One aspect of the present application provides a variable elastic modulus material whose elastic modulus varies in accordance with an intensity of a magnetic field applied to the variable elastic modulus material, and the variable elastic modulus material includes: a first elastic member including an elastic material and particles that are fixed in a dispersed state in the elastic material and magnetically polarized under an influence of the magnetic field; and a second elastic member that is different from the first elastic member and serves as a base material, wherein the first elastic member is disposed in the second elastic member.

In the thus-configured variable elastic modulus material of the present disclosure, the second elastic member formed as a base material is a member different from the first elastic member including the particles, and thus, the material for the base material can be versatile. In addition, in the variable elastic modulus material, the first elastic member in which the particles are dispersed is disposed in the second elastic member which serves as the base material. Thus, the variable elastic modulus material can be easily produced. Furthermore, properties of the first elastic member itself and the position of the first elastic member in the second elastic member are defined so as to control properties of the variable elastic modulus material. Thus, variations in response relative to a magnetic field can be easily reduced.

In the variable elastic modulus material, the first elastic member may be slender, the first elastic member may include a plurality of first elastic members, and the plurality of first elastic members may be disposed parallel to each other in the second elastic member.

In this configuration, since the first elastic member is slender, the particles can be easily dispersed with magnetic bonding being formed between the particles in the first elastic member. Thus, variations in response relative to a magnetic field can be easily reduced. In addition, since the slender first elastic members are disposed parallel to each other in the second elastic member, application of a magnetic field to the variable elastic modulus material in a direction in which the first elastic members extend makes it possible to make the elastic modulus (rigidity) of the variable elastic modulus material in a shear direction variable. As a result, the variable elastic modulus material can be easily designed.

In the variable elastic modulus material, the first elastic member may be slender, the first elastic member may include a plurality of first elastic members, some of the plurality of first elastic members which are arranged parallel to each other and whose longitudinal direction coincides with a first direction may be first-direction members, and the other first elastic members which are arranged parallel to each other and whose longitudinal direction coincides with a second direction intersecting the first direction may be second-direction members.

In this configuration, since the particles are oriented in two different directions in the second elastic member, the elastic modulus can be made variable in two directions by controlling the direction of a magnetic field applied in use in two directions as necessary.

In the variable elastic modulus material, the elastic material may be slender, and the particles may be provided on an outer periphery of a shaft of the elastic material of the first elastic member.

This configuration facilitates arrangement of the particles along the shaft of the slender elastic material. As a result, the variable elastic modulus material can be easily designed.

In the variable elastic modulus material, the variable elastic modulus material may be an elastic supporting element installed in a vehicle, and a longitudinal direction of the first elastic member may coincide with a direction intersecting a direction in which a load is applied to the variable elastic modulus material.

In this configuration, in a case where the variable elastic modulus material is used as an elastic supporting element (e.g., an elastic member constituting a mount, a bush, or a dynamic damper) installed in a vehicle, displacement and vibrations caused by a load applied to the variable elastic modulus material can be suitably adjusted by applying a magnetic field.

The present application also provides a method for producing a variable elastic modulus material whose elastic modulus varies in accordance with an intensity of a magnetic field applied to the variable elastic modulus material and which includes first elastic members including an elastic material and particles that are fixed in a dispersed state in the elastic material and magnetically polarized under an influence of the magnetic field and a second elastic member that is different from the first elastic members and serves as a base material, and the first elastic members are disposed in the second elastic member. The method includes: a first formation step of forming the first elastic members; a step of arranging the first elastic members formed in the first formation step along a predetermined direction in a molding die for the second elastic member; and a second formation step of forming the second elastic member by supplying a base material of the second elastic member into the molding die for the second elastic member in which the first elastic members are arranged.

In this method, the variable elastic modulus material in which a variation in particles is suitably reduced can be easily produced without the need for a complicated method for reducing a variation in particles by applying a magnetic field to a base material resin in which particles are dispersed such that the particles are oriented in a predetermined direction and solidifying the base material resin in this state. In addition, the variable elastic modulus material can be easily designed, and the thus obtained variable elastic modulus material has stable properties.

In the method, in the first formation step, slender grooves or cavities provided in a molding die for the first elastic members may be supplied with the particles together with the base material of the first elastic member.

In this method, since the base material is supplied to the slender grooves or cavities together with the particles, the particles can be easily oriented along the slender first elastic members. Thus, the variable elastic modulus material that suitably reduces a variation in particles can be easily produced. This variable elastic modulus material can be easily designed and has stable properties.

In the method, in the first formation step, the elastic material may be slender and the particles may be attached to a shaft of the elastic material.

In this method, the particles can be easily oriented along a predetermined direction in forming the first elastic members. Thus, the variable elastic modulus material that suitably reduces a variation in particles can be easily produced. This variable elastic modulus material can be easily designed and has stable properties.

In the method, in the first formation step, a mixture of the base material of the first elastic member and the particles may be linearly injected, thereby forming the first elastic members that are slender.

In this method, a mixture of the base material of the first elastic member and the particles is linearly injected, and thereby, the particles can be easily oriented along a predetermined direction. The slender first elastic member can be easily formed, and the variable elastic modulus material can be easily produced.

The present application also provides a method for producing a variable elastic modulus material whose elastic modulus varies in accordance with an intensity of a magnetic field applied to the variable elastic modulus material and which includes a first elastic member including an elastic material and particles that are fixed in a dispersed state in the elastic material and magnetically polarized under an influence of the magnetic field and a second elastic member that is different from the first elastic member and serves as a base material. The method includes the step of: forming a layer having a cross-sectional shape of the first elastic member and a cross-sectional shape of the second elastic member, wherein a process of overlaying the layer with another layer is repeated.

In this method, the first elastic member and the second elastic member do not need to be separately formed, and thus, the variable elastic modulus material can be easily produced.

The present application also provides a method for producing a variable elastic modulus material whose elastic modulus varies in accordance with an intensity of a magnetic field applied to the variable elastic modulus material and which includes a first elastic member including an elastic material and particles that are fixed in a dispersed state in the elastic material and magnetically polarized under an influence of the magnetic field and a second elastic member that is different from the first elastic member and serves as a base material. The method includes the steps of: forming the second elastic member having a plurality of slender gaps; and forming the first elastic member by filling the plurality of slender gaps in the second elastic member with a liquid mixture of a base material of the first elastic member and the particles.

In this method, it is unnecessary to dispose a plurality of slender first elastic members in a molding die for a second elastic member, and thus, the variable elastic modulus material can be more easily produced.

In the variable elastic modulus material of the present application, a material serving as a base material can be made versatile. The variable elastic modulus material can be easily produced. In addition, variations in response relative to a magnetic field can be easily reduced. With the method for producing the variable elastic modulus material of the present application, the variable elastic modulus material having suitable properties can be easily produced.

### BRIEF DESCRIPTION OF THE DRAWINGS

The advantages of the disclosure will become apparent in the following description taken in conjunction with the following drawings.

FIG. 1 is a perspective view illustrating a configuration of a variable elastic modulus material according to a first embodiment of the present disclosure.

FIG. 2A is a partial cross-sectional view of first elastic members of a first example.

FIG. 2B is a partial cross-sectional view of first elastic members of a second example.

FIG. 3A is an illustration for describing a method for forming first elastic members with a molding die.

FIG. 3B is another illustration for describing a method for forming first elastic members with a molding die.

FIG. 4 is an illustration for describing a method for forming first elastic members by linearly injecting a mixture of a base material and particles.

FIG. 5A shows a step in a first method for producing a variable elastic modulus material.

FIG. 5B shows another step of the first method for producing a variable elastic modulus material.

FIG. 6 is an illustration showing a second method for producing a variable elastic modulus material.

FIG. 7A is a first illustration showing a third method for producing a variable elastic modulus material.

FIG. 7B is a second illustration showing the third method for producing a variable elastic modulus material.

FIG. 8 illustrates an example of application of a variable elastic modulus material to a bush.

FIG. 9 illustrates an example of application of a variable elastic modulus material to a dynamic damper.

FIG. 10 is a perspective view of a variable elastic modulus material according to a second embodiment of the present disclosure.

### DETAILED DESCRIPTION

Preferred embodiments of the present disclosure regarding variable elastic modulus materials will be described with reference to the drawings.

### First Embodiment

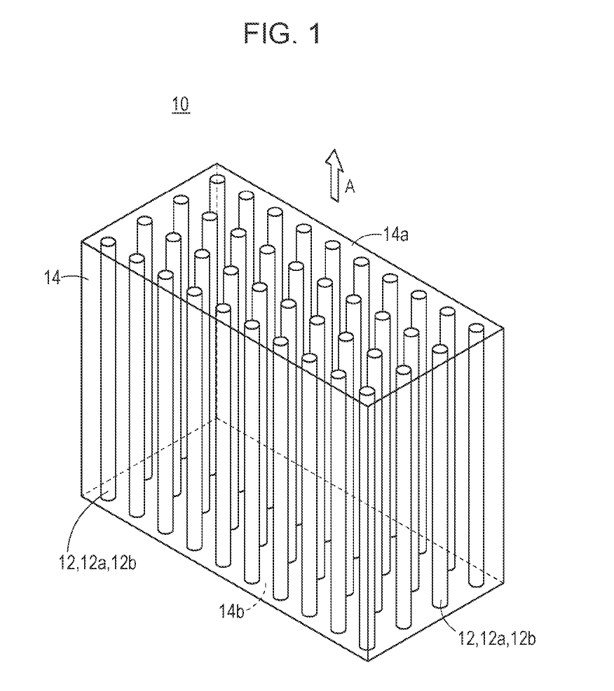

FIG. 1 is a perspective view illustrating a configuration of a variable elastic modulus material 10 according to a first embodiment of the present disclosure. The variable elastic modulus material 10 has an elastic modulus that varies in accordance with the intensity of an applied magnetic field. As illustrated in FIG. 1, the variable elastic modulus material 10 includes a plurality of first elastic members 12 and a second elastic member 14 serving as a base material of the variable elastic modulus material 10 and different from the first elastic members 12. The variable elastic modulus material 10 is a so-called magneto-rheological elastomer.

The first elastic members 12 are rectilinear and slender and are located inside the second elastic member 14. Such a shape of the first elastic members 12 can be expressed as long, linear, filiform, or columnar, for example, in addition to slender. The first elastic members 12 may have a slender sheet shape.

In the second elastic member 14, a plurality of (a large number of) first elastic members 12 are arranged parallel to each other. Specifically, the first elastic members 12 are oriented such that the longitudinal directions of the first elastic members 12 coincide with a line connecting two opposite outer planes of the second elastic member 14, and the first elastic members 12 are separated from one another in a direction orthogonal to the longitudinal direction in the second elastic member 14.

The first elastic members 12 may be evenly spaced or partially unevenly spaced with respect to each other.

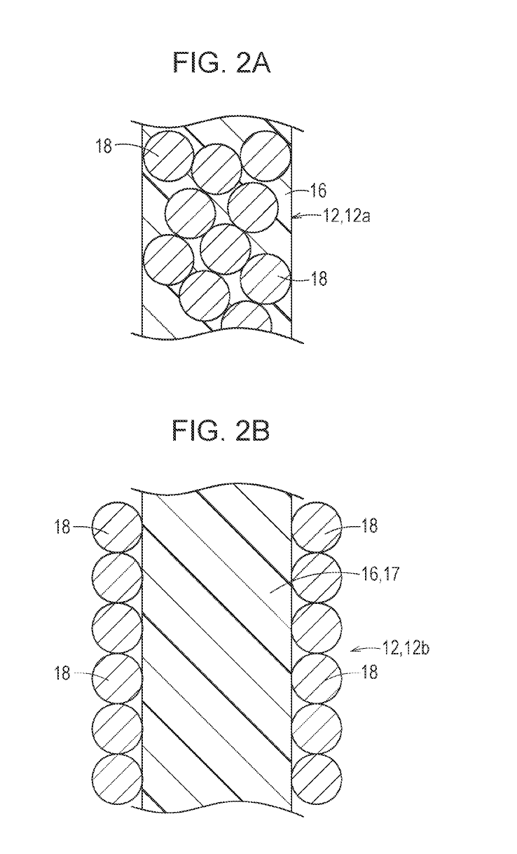

As illustrated in FIG. 2A, the first elastic members 12 include an elastic material 16 constituting the base material of the first elastic members 12 and particles 18 (magnetic particles) fixed in a dispersed state in the elastic material 16 and magnetically polarized under the influence of a magnetic field. In first elastic members 12a of one example (a first example), the large number of particles 18 are dispersed in the elastic material 16. Thus, the large number of particles 18 are oriented along the longitudinal direction of the first elastic members 12.

As illustrated in FIG. 2B, in first elastic members 12b of another example (a second example), the large number of particles 18 are disposed on the outer peripheries of shafts 17 constituted by the slender elastic material 16. Thus, the large number of particles 18 are oriented along the longitudinal direction of the first elastic members 12b.

The particles 18 are magnetically polarized under the influence of a magnetic field and are conductive. Examples of a material for the particles 18 include known materials including metals such as a magnetic soft ion, oriented silicon steel, Mn—Zn ferrite, Ni—Zn ferrite, magnetite, cobalt, and nickel, organic substances such as 4-methoxy benzylidene-4-acetoxy aniline, triaminobenzene polymer, and organic and inorganic complexes such as ferrite-dispersed anisotropy plastic.

The shape of the particles 18 may be, but is not limited to, spherical, acicular, or flat, for example. The size of the particles 18 may be, but is not limited to, about 0.01 μm to 500 μm, for example.

The particles 18 disposed inside or on the outer peripheries of the elastic material 16 show a small degree of interaction when a magnetic field is not applied, and show an increased attraction to each other due to a magnetism interaction when a magnetic field is applied. The particles 18 are preferably dispersed such that magnetic bonding occurs in chains between the particles 18 upon application of a magnetic field.

For example, the particles 18 are dispersed such that contact areas among the particles 18 can be small when a magnetic field is not applied and can be increased by magnetic bonding when a magnetic field is applied. Under no application of a magnetic field, the particles 18 may be dispersed not to contact each other or dispersed such that some of the particles 18 contact each other and are continuous. That is, the particles 18 do not need to be continuous by contacting each other and only need to substantially contact each other upon application of a magnetic field.

Examples of the elastic material 16 include known polymer materials having viscoelasticity at room temperature, such as ethylene-propylene rubber, butadiene rubber, isoprene rubber, and silicone rubber.

The second elastic member 14 is a member having viscoelasticity as a matrix. The second elastic member 14 has principal surfaces 14a and 14b located at opposite sides and orthogonal to a predetermined axis. The principal surface 14a is parallel to the principal surface 14b. The second elastic member 14 may have any shape, such as a cuboid or a cylindrical column. FIG. 1 illustrates the second elastic member 14 in the shape of a cuboid. The principal surface 14a and the principal surface 14b are a pair of opposite outer surfaces in a case where the second elastic member 14 is a cuboid and are end surfaces orthogonal to the axis in a case where the second elastic member 14 is a cylindrical column.

Examples of a material for the second elastic member 14 may be the material for the elastic material 16 of the first elastic members 12 described above. The elastic material 16 of the first elastic members 12 and the second elastic member 14 may be made of the same material or different materials. The second elastic member 14 may be made of natural rubber.

In the thus-configured variable elastic modulus material 10, upon application of a magnetic field in direction A in FIG. 1, the particles 18 are magnetically polarized according to the intensity of the magnetic field, and form magnetic bonds. At this time, a force of causing the particles 18 to be arranged along magnetic lines of force of the magnetic field, and thus, an apparent spring constant increases. That is, the elastic modulus of the variable elastic modulus material 10 becomes larger than the elastic modulus (rigidity) of the second elastic member 14 as the base material itself. As the intensity of the magnetic field applied to the variable elastic modulus material 10 increases, the magnetic bonding between the particles 18 increases, and the elastic modulus of the variable elastic modulus material 10 increases.

The variable elastic modulus material 10 of this embodiment is basically configured as described above. Operation and advantages of the variable elastic modulus material 10 will now be described.

In the variable elastic modulus material 10 configured as described above, the second elastic member 14 formed as the base material is different from the first elastic members 12 including the particles 18, and thus, a material serving as the base material is not limited to a particular material. Properties of the first elastic members 12 alone can be controlled by applying an extremely weak current across the first elastic members 12 so as to measure the electric resistance thereof. In addition, since the first elastic members 12 in which the particles 18 are dispersed are disposed inside the second elastic member 14 as the base material, the variable elastic modulus material 10 can be easily produced. Furthermore, properties of the variable elastic modulus material 10 can be controlled by defining properties of the first elastic members 12 and the position of the first elastic members 12 in the second elastic member 14. Thus, variations in response to a magnetic field can be reduced.

In this embodiment, since the first elastic members 12 are slender, the particles 18 can be easily dispersed through the formation of magnetic bonds between the particles 18 in the first elastic members 12. Thus, variations in response to the magnetic field can be easily reduced. In addition, since the slender first elastic members 12 are arranged parallel to each other in the second elastic member 14, application of a magnetic field to the variable elastic modulus material 10 in the extension direction of the first elastic members 12 can vary the elastic modulus (rigidity) of the variable elastic modulus material 10 in a shear direction. As a result, the variable elastic modulus material 10 can be easily designed.

As illustrated in FIG. 2B, the first elastic members 12 are configured such that the large number of particles 18 are disposed on the outer peripheries of the shafts 17 constituted by the slender elastic material 16, and the particles 18 can be easily arranged along the shafts 17, thereby easily designing the variable elastic modulus material 10.

Methods for producing a variable elastic modulus material 10 will now be described.

A method for producing a variable elastic modulus material 10 (a first method) includes a first formation step of forming first elastic members 12, an arrangement step of arranging the first elastic members 12 in a predetermined position, and a second formation step of forming a second elastic member 14.

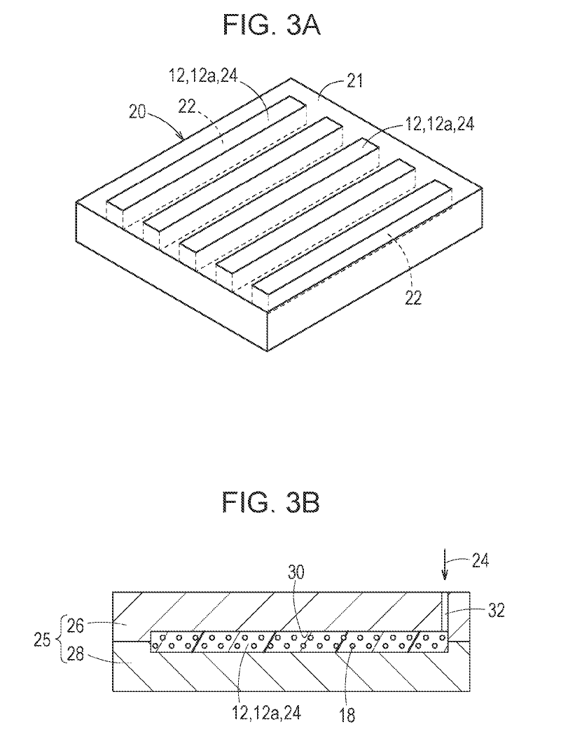

In the case of forming first elastic members 12 (12a) illustrated in FIG. 2A, in the first formation step, particles 18 and a base material (a liquefied material) of first elastic members 12 are supplied into slender grooves 22 formed in a molding die 20 (a die) for the first elastic members 12 as illustrated in FIG. 3A, for example. In the example in FIG. 3A, the slender grooves 22 that face upward are formed in an upper surface 21 of the molding die 20 for the first elastic members 12. In the first formation step, the base material of the first elastic members 12 is mixed with the particles 18, and a liquid mixture 24 in which the particles 18 are dispersed in the base material is prepared beforehand. The liquid mixture 24 is then poured into the grooves 22 and solidifies, thereby producing first elastic members 12.

In the first formation step, as illustrated in FIG. 3B, slender first elastic members 12 (12a) may be formed by injection molding. Specifically, a molding die 25 for the first elastic members 12 is constituted by a first die 26 and a second die 28, and a slender cavity 30 is formed between the first die 26 and the second die 28. In this case, the cavity 30 is filled with the liquid mixture 24 as a mixture of the base material and particles 18 through a pouring channel 32 formed in the first die 26. Then, the mixture solidifies in the cavity 30, thereby producing the first elastic members 12 illustrated in FIG. 2A.

In this method, the base material and the particles 18 are supplied to the slender grooves 22 or the cavity 30, and thus, the particles 18 can be easily oriented along the slender shapes of the first elastic members 12a. Accordingly, the variable elastic modulus material 10 that suitably reduces a variation in the particles 18 can be easily produced. This variable elastic modulus material 10 can be easily designed and has stable properties.

In the case of forming the first elastic members 12b illustrated in FIG. 2B, in the first formation step, particles 18 are attached to the outer peripheries of the shafts 17 constituted by the slender elastic material 16. In this case, an adhesive is applied over the outer peripheries of the shafts 17 and the particles 18 attach to these outer peripheries of the shafts 17 to which the adhesive is attached. After attachment of the particles 18 to the outer peripheries of the shafts 17, a coating of an elastic material is provided as a protective layer on the outer peripheries of the shafts 17 so as to prevent detachment of the particles 18.

With this method, the particles 18 can be easily oriented along a predetermined direction during formation of the first elastic members 12b. Accordingly, the variable elastic modulus material 10 that suitably reduces a variation in the particles 18 can be easily produced. This variable elastic modulus material 10 can be easily designed and has stable properties.

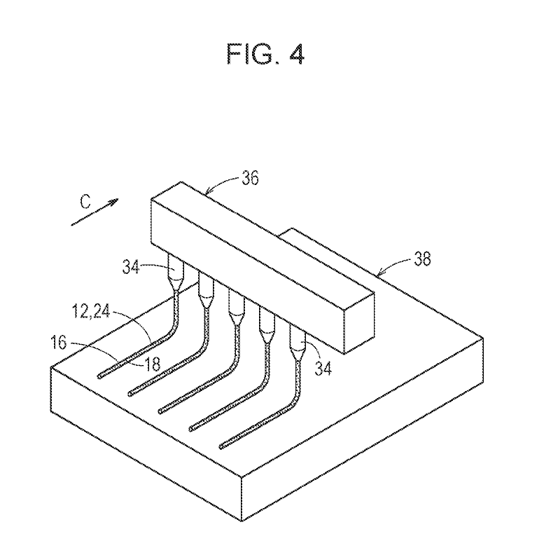

As illustrated in FIG. 4, in the first formation step, a mixture of the base material of the first elastic members 12 and the particles 18 may be linearly injected so as to form the slender first elastic members 12. In this case, for example, while nozzles 34 that are injection units are moved linearly in direction C (a horizontal direction), a liquid mixture 24 obtained by previously mixing a base material (a liquefied material) and particles 18 is caused to flow downward from the nozzles 34 toward a formation stage 38. Then, the liquid mixture 24 is placed rectilinearly on the formation stage 38. By solidifying the liquid mixture 24, slender first elastic members 12 are obtained. In the case of FIG. 4, a supply unit 36 including the multiple nozzles 34 moves linearly and horizontally and the liquid mixture 24 is injected linearly downward from the nozzles 34, thereby forming the multiple first elastic members 12 at the same time.

In this method, the mixture of the base material of the first elastic members 12 and the particles 18 is injected linearly, thereby orienting the particles 18 along the predetermined direction in a simple manner. The particles 18 may be placed along the predetermined direction in a simple manner. Accordingly, the slender first elastic members 12 can be easily formed, and thus, the variable elastic modulus material 10 can be easily produced.

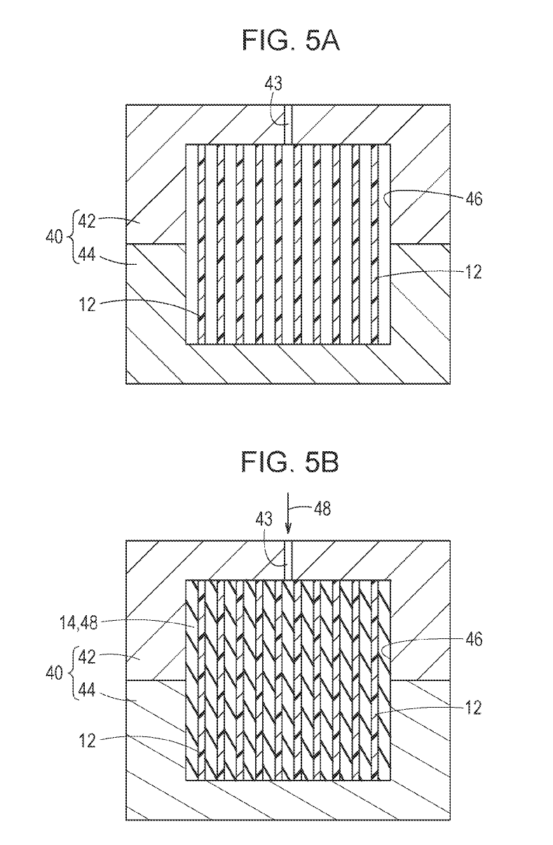

As illustrated in FIG. 5A, in the arrangement step, the first elastic members 12 formed in the first formation step are arranged while being oriented in a predetermined direction in a molding die 40 for the second elastic member 14. Specifically, the first elastic members 12 are disposed so as to be parallel to each other and spaced apart from each other in the molding die 40 for the second elastic member 14. In the case of FIG. 5 A, the molding die 40 for the second elastic member 14 includes a first die 42 (an upper die) and a second die 44 (a lower die), and the first die 42 and the second die 44 form a cavity 46 therein. The cavity 46 has a shape corresponding to the shape of the second elastic member 14.

As illustrated in FIG. 5B, in the second formation step, a base material 48 (a liquefied material) of the second elastic member 14 is supplied to the molding die 40 for the second elastic member 14 in which the first elastic members 12 are arranged, thereby forming the second elastic member 14. Specifically, the cavity 46 is filled with the liquefied base material 48 through a pouring channel 43 formed in the first die 42. By solidifying the base material 48, the second elastic member 14 in which the first elastic members 12 are disposed is obtained.

Through the first formation step, the arrangement step, and the second formation step, the variable elastic modulus material 10 can be obtained. The first method described above can be used to easily produce the variable elastic modulus material 10 that suitably reduces a variation in the particles 18 without the need for a complicated method for reducing a variation in the particles 18 by applying a magnetic field to a base material resin in which the particles 18 are dispersed so as to orient the particles 18 in a predetermined direction and by allowing the base material resin to solidify in this state. In addition, the obtained variable elastic modulus material 10 can be easily designed and has stable properties.

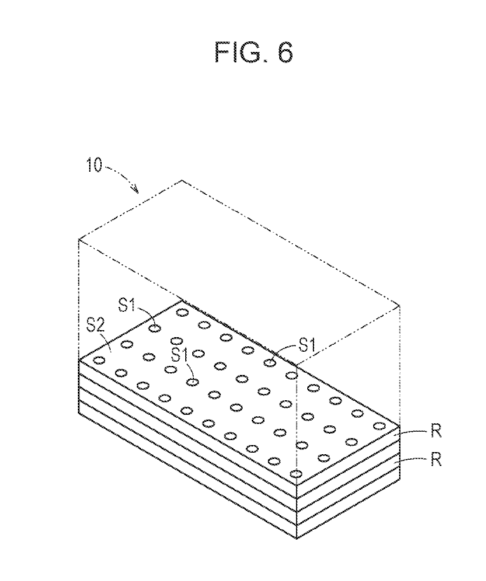

As illustrated in FIG. 6, another method (a second method) for producing the variable elastic modulus material 10 includes the step of forming a layer R having a cross-sectional shape S1 of the first elastic members 12 and a cross-sectional shape S2 of the second elastic member 14, the layer R is overlaid with another layer R, thereby forming the variable elastic modulus material 10. The second method can be performed with, for example, a 3D printer. In the case of using a 3D printer, fused deposition modeling or ink jet printing, for example, can be employed.

Fused deposition modeling is a technique of forming a three-dimensional object by stacking fused resin bit by bit while extruding the resin with a printer head.

In the case of forming the variable elastic modulus material 10 by fused deposition modeling, the printer head includes a first nozzle for injecting the liquid mixture 24 of the base material of the first elastic members 12 and the particles 18 and a second nozzle for injecting the base material of the second elastic member 14. The flow of the material from the first nozzle and the flow of the material from the second nozzle are individually controlled such that the layer R having the cross-sectional shape S1 of the first elastic members 12 and the cross-sectional shape S2 of the second elastic member 14 is formed, and such layers R are stacked sequentially, thereby forming the variable elastic modulus material 10.

Ink jet printing is a technique for printing a stacked surface by injecting fine particles of ultraviolet curing resin from an ink jet head, and ultraviolet light is applied in order to solidify the stacked surface.

In the case of forming the variable elastic modulus material 10 by using ink jet printing, the ink jet head includes a first injection nozzle for injecting fine particles of the liquid mixture 24 of the base material of the first elastic members 12 and the particles 18 and a second injection nozzle for injecting fine particles of the base material of the second elastic member 14. The injection of fine particles from the first injection nozzle and the injection of fine particles from the second injection nozzle are individually controlled such that a layer having a cross-sectional shape S1 of the first elastic members 12 and a cross-sectional shape S2 of the second elastic member 14 is formed, and such layers are stacked sequentially, thereby forming the variable elastic modulus material 10.

In the second method, the first elastic members 12 and the second elastic member 14 do not need to be formed separately, and thus, the variable elastic modulus material 10 can be easily produced.

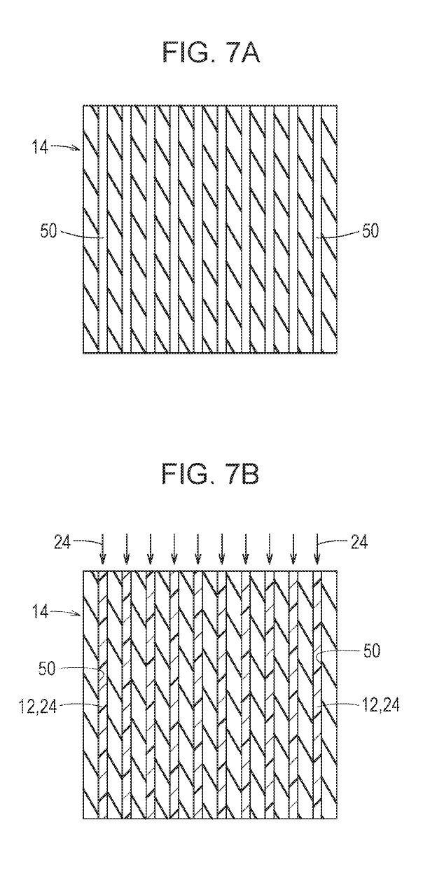

Referring to FIGS. 7A and 7B, yet another method (a third method) for producing a variable elastic modulus material 10 will be described. The third method includes a base material formation step (FIG. 7A) of forming a second elastic member 14 in which a plurality of slender gaps 50 are provided and a filling step (FIG. 7B) of filling the gaps 50 of the second elastic member 14 with a liquid mixture 24 of a base material of the first elastic members 12 and the particles 18 and forming first elastic members 12.

In the base material formation step, the slender gaps 50 are parallel to each other and spaced apart from each other in the second elastic member 14. In this case, after formation of the second elastic member 14 with no gaps 50, a plurality of gaps 50 may be formed by perforation (e.g., a mechanical process such as drilling or laser material processing). Alternatively, the second elastic member 14 with gaps 50 may be formed by injection molding or stereolithography using, for example, a 3D printer.

In the filling step, the liquid mixture 24 is poured into the gaps 50 formed in the second elastic member 14 and allowed to solidify. Then, the first elastic members 12 that are parallel to each other and spaced apart from each other are formed in the second elastic member 14.

Next, some examples of application of the variable elastic modulus material 10 will be described.

For example, the variable elastic modulus material 10 is an elastic supporting element installed in a vehicle, and the longitudinal direction of the first elastic members 12 may intersect the direction in which a load is applied to the variable elastic modulus material 10. Examples of the elastic supporting element installed in the vehicle include an engine mount between a vehicle body frame and an engine, a bush between the vehicle body frame and a knuckle supporting a suspension arm and a wheel, and a dynamic damper for reducing vibration caused by a vibrator.

This configuration can suitably adjust a displacement or vibration as a result of a load applied to the variable elastic modulus material 10 by applying a magnetic field in a case where the variable elastic modulus material 10 is used as an elastic supporting element of a vehicle.

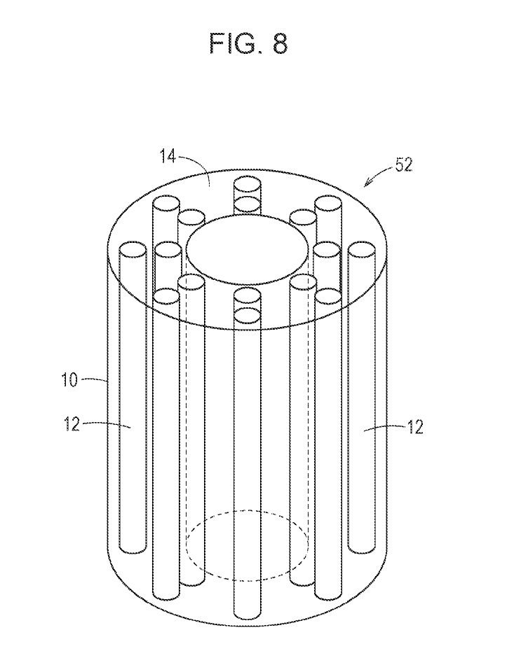

As illustrated in FIG. 8, in the case of applying the variable elastic modulus material 10 to a bush 52, the variable elastic modulus material 10 is formed in a cylinder shape, for example. An electromagnet (coil), not shown, as a magnetic field application unit is disposed on either or one axial side of the cylindrical bush 52, and the intensity of a magnetic field applied to the bush 52 is adjusted, thereby changing an elastic modulus of the bush 52.

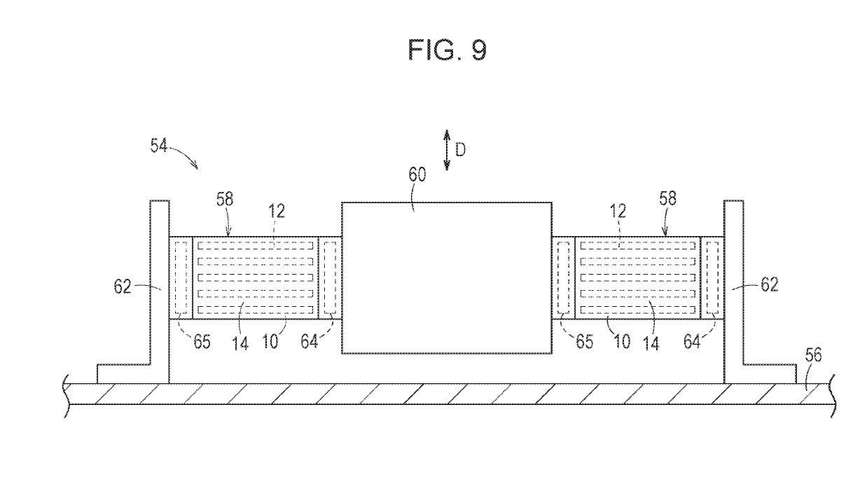

As illustrated in FIG. 9, in the case of applying the variable elastic modulus material 10 to a dynamic damper 54, a mass member 60 including the variable elastic modulus material 10 is supported through elastic body units 58 relative to a vibrator 56. In the case of FIG. 9, the two elastic body units 58 are supported by brackets 62 attached to the vibrator 56, and the mass member 60 is bridged across the two elastic body units 58 such that the mass member 60 can be shaken in directions D. Thus, the dynamic damper 54 operates so as to reduce vibrations in directions D. Directions D can be vertical, horizontal, or front-rear directions of the vehicle. Only one elastic body unit 58 may be provided.

In the elastic body unit 58, electromagnets 64 and 65 (coils) as magnetic field application units are disposed on both sides of the variable elastic modulus material 10. The elastic modulus of the variable elastic modulus material 10 can be changed by adjusting the intensity of a magnetic field applied to the variable elastic modulus material 10 such that the variable elastic modulus material 10 vibrates at a reduced oscillation frequency in an opposite phase to the oscillation frequency of the vibrator 56, and vibrations can be reduced following the oscillation frequency of the vibrator 56. One of the electromagnets 64 and 65 disposed on both sides of the variable elastic modulus material 10 in the elastic body unit 58 may be omitted.

### Second Embodiment

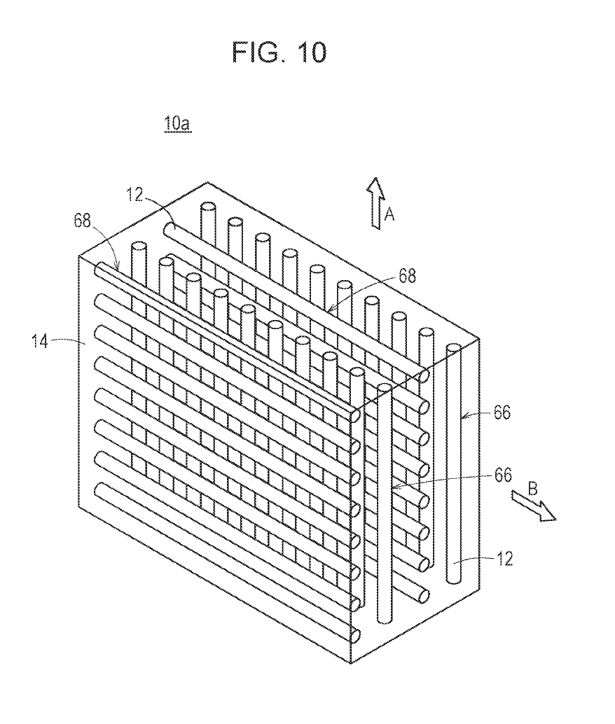

FIG. 10 is a perspective view of a variable elastic modulus material 10a according to a second embodiment of the present disclosure. In the second embodiment, components having the same or equivalent functions and advantages as those of the first embodiment are denoted by the same reference numerals, and description thereof will not be repeated.

In the variable elastic modulus material 10a, first-direction members 66 constituted by parallel first elastic members 12 whose longitudinal direction coincides with a first direction and a second-direction member 68 constituted by parallel first elastic members 12 whose longitudinal direction coincides with a second direction intersecting the first direction.

Specifically, in FIG. 10, the first elastic members 12 constituting the first-direction members 66 are parallel to each other and spaced apart from each other in the second elastic member 14. The first elastic members 12 constituting the second-direction member 68 are parallel to each other and spaced apart from each other in the second elastic member 14. The first direction is orthogonal to the second direction. The number of the first-direction members 66 is two or more, and the number of the second-direction member 68 is two or more. The first-direction members 66 and the second-direction member 68 are alternately arranged.

In FIG. 10, an electromagnet serving as a magnetic field application unit is disposed at each or one side of the variable elastic modulus material 10a along direction A that coincides with the first direction. The elastic modulus relative to deformation in the shear direction along the plane orthogonal to direction A can be adjusted by using the intensity of a magnetic field applied to the variable elastic modulus material 10a in direction A.

An electromagnet serving as a magnetic field application unit is disposed on each or one side of the variable elastic modulus material 10a along direction B that coincides with the second direction. The elastic modulus relative to deformation in the shear direction along the plane orthogonal to direction B can be adjusted by using the intensity of a magnetic field applied to the variable elastic modulus material 10a.

As described above, in the variable elastic modulus material 10a of this embodiment, the particles 18 are oriented in two different directions (i.e., the first direction and the second direction) in the second elastic member 14. Thus, the elastic modulus can be made variable in two directions by controlling the direction of a magnetic field applied in use in two directions as necessary.

In a manner similar to the variable elastic modulus material 10 of the first embodiment, the variable elastic modulus material 10a of the second embodiment is applicable to a bush, a mount, and a dynamic damper, for example. The variable elastic modulus material 10a can be produced by a method similar to the method for producing the variable elastic modulus material 10 of the first embodiment.

In the second embodiment, components already described in the first embodiment show the same or similar functions and advantages as/to those of the first embodiment.

Although preferred embodiments of the present disclosure have been described, the present disclosure is not limited to these embodiments, and can be variously modified within the scope of the present disclosure. Although a specific form of embodiment has been described above and illustrated in the accompanying drawings in order to be more clearly understood, the above description is made by way of example and not as limiting the scope of the invention defined by the accompanying claims. The scope of the invention is to be determined by the accompanying claims. Various modifications apparent to one of ordinary skill in the art could be made without departing from the scope of the invention. The accompanying claims cover such modifications.

What is claimed is:

1. A variable elastic modulus material having elastic modulus varying in accordance with an intensity of a magnetic field applied to the variable elastic modulus material, the variable elastic modulus material comprising:
a first elastic member including an elastic material and particles that are fixed in a dispersed state in the elastic material, the particles being magnetically polarized under an influence of the magnetic field; and
a second elastic member that is different from the first elastic member and serves as a base material of the variable elastic modulus material, wherein
the first elastic member is disposed in the second elastic member.

2. The variable elastic modulus material of claim 1, wherein
the first elastic member has a slender shape,
the first elastic member comprises a plurality of first elastic members, and
the plurality of first elastic members are disposed parallel to each other in the second elastic member.

3. The variable elastic modulus material of claim 1, wherein
the first elastic member has a slender shape,
the first elastic member comprises a plurality of first elastic members, and
wherein the plurality of first elastic members include first-direction members having longitudinal direction coinciding with a first direction and arranged parallel to each other, and second-direction members having longitudinal direction coinciding with a second direction intersecting the first direction and arranged parallel to each other.

4. The variable elastic modulus material of claim 1, wherein
the first elastic member includes a shaft member having a slender shape and made of the elastic member, the particles are provided on an outer periphery of the shaft member.

5. The variable elastic modulus material of claim 1, wherein
the variable elastic modulus material is an elastic supporting element installed in a vehicle, and
a longitudinal direction of the first elastic member coincides with a direction intersecting a direction in which a load is applied to the variable elastic modulus material.

6. A method for producing a variable elastic modulus material having elastic modulus varying in accordance with an intensity of a magnetic field applied to the variable elastic modulus material and which includes first elastic member including an elastic material and particles that are fixed in a dispersed state in the elastic material, the particles being magnetically polarized under an influence of the magnetic field, and a second elastic member that is different from the first elastic member and serves as a base material, the first elastic member being disposed in the second elastic member, the method comprising:
a first formation step of forming the first elastic member;
a step of arranging the first elastic member formed in the first formation step along a predetermined direction in a molding die for the second elastic member; and
a second formation step of forming the second elastic member by supplying a base material of the second elastic member into the molding die for the second elastic member in which the first elastic member is arranged.

7. The method of claim 6, wherein
the first formation step includes supplying the particles together with the base material of the first elastic member to slender grooves or cavities provided in a molding die for the first elastic member.

8. The method of claim 6, wherein
the first formation step includes attaching the particles on an outer periphery of a shaft member having a slender shape and made of the elastic material.

9. The method of claim 6, wherein
the first formation step includes injecting linearly a mixture of the base material of the first elastic member and the particles to form the first elastic member that has a slender shape.

10. A method for producing a variable elastic modulus material having elastic modulus varying in accordance with an intensity of a magnetic field applied to the variable elastic modulus material and which includes a first elastic member including an elastic material and particles that are fixed in a dispersed state in the elastic material, the particles being magnetically polarized under an influence of the magnetic field, and a second elastic member that is different from the first elastic member and serves as a base material, the first elastic member being disposed in the second elastic member, the method comprising the step of:
forming a layer including a cross-sectional shape of the first elastic member and a cross-sectional shape of the second elastic member;
overlaying the layer with another layer of the layer; and
repeating the step of the overlaying.

11. A method for producing a variable elastic modulus material having elastic modulus varying in accordance with an intensity of a magnetic field applied to the variable elastic modulus material and which includes a first elastic member including an elastic material and particles that are fixed in a dispersed state in the elastic material, and the particles being magnetically polarized under an influence of the magnetic field, and a second elastic member that is different from the first elastic member and serves as a base material, the first elastic member being disposed in the second elastic member, the method comprising the steps of:
forming the second elastic member having a plurality of slender gaps; and
forming the first elastic member by filling the plurality of slender gaps of the formed second elastic member with a liquid mixture of a base material of the first elastic member and the particles.

12. The variable elastic modulus material of claim 2, wherein the particles are oriented along a longitudinal direction of the slender shape.

13. The variable elastic modulus material of claim 1, wherein the first elastic member has a long shape, a linear shape, a filiform shape, or a columnar shape.

14. A vehicle comprises the variable elastic modulus material of claim 5.
